(19) United States
(12) Patent Application Publication
(10) Pub. No.: US 2024/0049902 A1
(43) Pub. Date: Feb. 15, 2024

(54) BEVERAGE PREPARATION DEVICE AND BEVERAGE MACHINE

(71) Applicant: Melitta Professional Coffee Solutions GmbH & Co. KG, Minden (DE)

(72) Inventors: Dominik RINNE, Wunstorf (DE); Dennis THIELEMANN, Rahden (DE); Bernd BUCHHOLZ, Rahden (DE)

(73) Assignee: Melitta Professional Coffee Solutions GmbH & Co. KG, Minden (DE)

(21) Appl. No.: 18/273,056

(22) PCT Filed: Jan. 21, 2022
(86) PCT No.: PCT/EP2022/051322

§ 371 Date: Jul. 19, 2023

(30) Foreign Application Priority Data
Jan. 21, 2021 (DE) 10 2021 101 271.6

(51) Int. Cl. A47J 31/40; A47J 31/44; A47J 31/46; A47J 31/60

(52) U.S. Cl. CPC A47J 31/401; A47J 31/4403; A47J 31/469; A47J 31/461; A47J 31/60

(57) ABSTRACT

A beverage preparation device for preparing instant beverages has a conveyor system, a mixing chamber, at least one pump, at least one heat exchanger, at least one valve and a control device. The mixing chamber has at least two flush-in connections arranged at a distance from one another in the direction of a chamber axis of the mixing chamber. The mixing chamber has chamber sections arranged one behind the other, with inner diameters decreasing from the inlet to the outlet of the mixing chamber. The chamber sections are all formed with conical inner surfaces and the mixing chamber comprises a free of mixer/mixing wheels, asymmetrical structure with a first chamber and a second chamber arranged one behind the other. A chamber axis of the first chamber and a chamber axis of the second chamber are offset from one another and thus arranged eccentrically from one another.

The invention relates to a beverage preparation device according to the preamble of claim 1. The invention also relates to a beverage machine according to the preamble of claim 15.

Such beverage preparation devices are used to prepare beverages by dissolving so-called instant or beverage powders in liquid media, mainly in water at different temperatures. The instant powder is, for example, milk powder, cocoa powder, chocolate powder, coffee powder, tea powder, etc.

EP 1 859 715 B1 illustrates a device for automatically dissolving instant powder, in particular milk powder, in hot water and in particular for foaming.

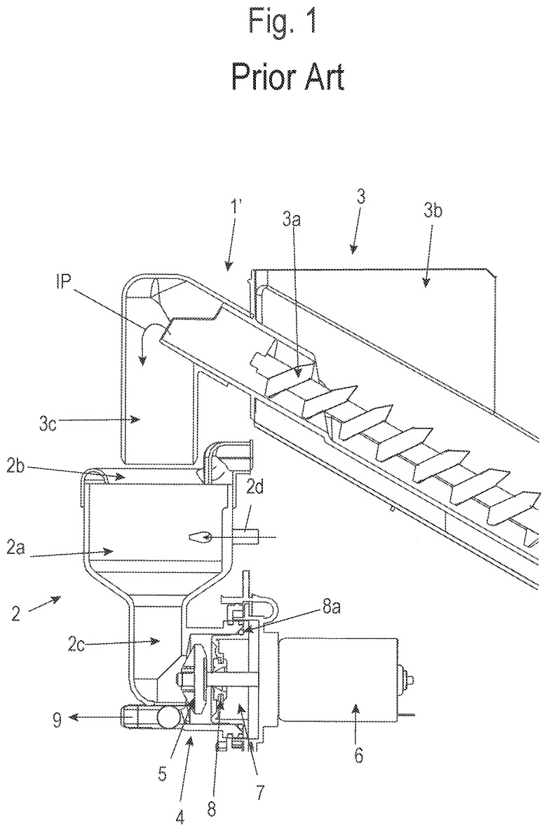

FIG. 1 shows a schematic view of an embodiment of a prior art beverage preparation device 1′.

The beverage preparation device 1′ comprises a mixing chamber 2, a conveyor system 3, a mixer chamber 4 with a mixer wheel 5 and a mixer drive 6.

The mixing chamber 2 comprises a hollow-cylindrical chamber section 2a, which is covered on its upper side with a suction bonnet 2b and merges on its underside via a conical floor into a tube section 2c. The tube section 2c is bent at a right angle at its free end and connected to the mixer chamber 4. In the mixer chamber 4, the mixer wheel 5 is arranged on a shaft of the mixer drive 6, rotatably driven by the latter. The mixer chamber 4 is attached to a holder 7, which is mounted on the mixer drive 6. The holder 7 is inserted into the mixer chamber 4 in the shape of a pot. Its floor wall comprises a bearing and a bearing seal 8 for the shaft. Another housing seal 8a seals an edge of the holder 7 against a circumferential wall of the mixer chamber 4.

During operation of the beverage preparation device 1′, instant powder IP is conveyed by the conveyor system 3 with a conveyor element 3a, e.g. with a conveyor screw, from a storage container 3b via a chute 3c into the chamber section 2a of the mixing chamber 2 through an opening of the suction bonnet 2b. The instant powder IP thus falls from above into the chamber section 2a and is mixed with flushed-in water. The water is flushed into the chamber section 2a through a lateral inlet 2d, which opens into the chamber section 2a through a chamber wall. The flushed-in water and the supplied instant powder IP are conveyed through the tube section 2c into the mixer chamber 4. In the mixer chamber 4, a strong mixing takes place in the lower area of the tube section 2c opening into the mixer chamber 4 by the mixer wheel 5 rotated by the mixer drive 6. This causes the instant powder IP to dissolve in the water that has been flushed in. The product mixed in this way is discharged through a drain 9 connected to the mixer chamber 4. Any water vapour produced is extracted through the extraction bonnet 2b.

In the course of constantly increasing convenience in the operation, cleaning and service of beverage preparation equipment, there is a need for improvement of the current designs.

The invention therefore has the object of creating an improved beverage preparation device, whereby costs for components, assembly and service are significantly reduced or at least maintained.

The invention solves this problem by a beverage preparation device having the feature of claim 1 and by a beverage machine according to claim 15.

One idea of the invention is to provide a mixing chamber with two flush-ins of liquid media, such as water, for dissolving instant powder in the media.

A beverage preparation device according to the invention for preparing instant beverages, comprising a conveyor system, a mixing chamber, at least one pump, at least one heat exchanger, at least one valve and a control device, is characterised by the mixing chamber comprising at least two flush-in connections for the respective injection of a jet of a liquid medium into the mixing chamber, the at least two flush-in connections being arranged at a distance from one another in the direction of a chamber axis of the mixing chamber.

A particular advantage is that mixing of instant powder with the medium and dissolving in it is only done by injecting two jets of the liquid medium. The instant powder is dissolved in the media by the two liquid media (mainly cold or hot water) and the mechanical forces created by the injection.

In a particularly preferred embodiment, it is provided that the mixing chamber comprises a structure that is free of mixer/mixing wheels. An additional component such as a mixer wheel with associated drive motor is advantageously not required. A further advantage results from the fact that no drive motor is necessary.

A beverage machine/beverage vending machine comprises at least one such beverage preparation device. The beverage machine can be, for example, a coffee machine, a stand-alone coffee machine, a fully automatic coffee machine or the like.

A method of preparing an instant beverage with a mixing chamber according to the invention comprises the method steps of (S1) providing a beverage preparation device with the mixing chamber comprising at least two flush-in connections; (S2) charging the first flush-in connection with a first liquid medium and injecting the first medium in a first jet into a first chamber section of the mixing chamber; (S3) introducing instant powder into the first chamber section of the mixing chamber, premixing the introduced instant powder with the first medium injected through the first injection port, and transporting this premix further down the mixing chamber through a second chamber section into a third chamber section; and (S4) applying a second liquid medium to the second flush-in connection and injecting the second medium in a second stream into the third chamber section of the mixing chamber and creating a vortex to completely mix the instant powder with the first and second media and dissolve in the media to form the instant beverage.

Advantageously, a liquid medium is simply flushed into the first chamber section through the first flush-in connection. This ensures an advantageous rinsing of the inner walls and absorbs the instant powder. As a result, the powder is transported further into the lower section of the chamber. There, another liquid medium enters the third chamber section through the second flush-in connection. This advantageously ensures the formation of a vortex. In the vortex, the final mixing of the media and the instant powder takes place, whereby the instant powder dissolves completely in the media. Gravity then transports the finished product to the outlet.

Advantageous further embodiments of the invention are indicated by the dependent claims.

In a particularly preferred embodiment, the mixing chamber comprises chamber sections arranged one behind the other, whereby the inner diameters (clear diameters) of these chamber sections decrease starting from a chamber inlet of the mixing chamber to a chamber outlet of the mixing chamber. By reducing the diameters, an advantageous increase in the flow rate of the mixtures flowing through can be achieved.

It is advantageous if the chamber sections arranged one behind the other are alternately formed with cylindrical and conical inner surfaces.

In a particularly preferred embodiment, the chamber sections arranged one behind the other are all formed with conical inner surfaces.

It is advantageous that the mixing chamber is designed as a one-piece hollow body rotationally symmetrical about a chamber axis, as this is easy to manufacture and no additional seals are necessary between the chamber sections. The mixing chamber can be described as seal-free as there are no wearing parts.

In a particularly preferred embodiment, the mixing chamber comprises an asymmetrical structure with a first chamber and a second chamber arranged one behind the other, whereby a chamber axis of the first chamber and a chamber axis of the second chamber are offset from one another by an offset and are thus arranged eccentrically to one another. This has the advantage that the chamber does not clog so quickly if the instant powder passes through the chamber directly into the chamber outlet when no flushing is active and sticks therein.

Thereby, the first chamber of the mixing chamber is formed with a plane section comprising a floor with an inner surface, the floor being arranged with a circumferential angle α to a horizontal slightly inclined inwards to the chamber axis of the second chamber, the angle α having a value which is in a range of 5° to 10°, preferably 7.5°. This is advantageous as the instant powder fed into the upper chamber through the chamber inlet falls first onto the inner surface of the floor of the plane section.

The mixing chamber can be made of a metal material, a plastic or a combination of metal material and plastic and can be designed without seals. This can advantageously be done in an injection moulding process. The plastic also saves weight.

In a further embodiment, a first flush-in connection of the at least two flush-in connections comprises a through opening which opens into the first chamber section of the mixing chamber, and a second flush-in connection of the at least two flush-in connections comprises a through opening which opens into the third chamber section of the mixing chamber. By designing the through openings, an advantageous adaptation of the jets of the flushed-in media can be achieved.

An advantageous increase in the flow velocity of the flushed jet of the through opening of the second flush-in connection can be achieved by the through opening of the second flush-in connection comprising a smaller inner diameter than that of the through opening of the first flush-in connection. This can have an advantageous effect on the formation of a vortex.

In a still further embodiment, it is provided that the first flush-in connection and the second flush-in connection can be pre-set or adjustably charged via a common valve or each via a separate valve independently of one another with a medium or different media simultaneously or with a time delay. An advantage here is that the induction can be switched on and off and can thus be dosed.

It is also advantageous if the first flush-in connection and the second flush-in connection can be pre-set or adjustably charged independently of each other via a separate valve in each case with a medium or different media simultaneously or with a time delay. In this way, for example three different media (instant powder, water and e.g. milk or other flavour additives) can be mixed and dissolved in the mixing chamber.

In one embodiment, the mixing chamber is arranged vertically and comprises a chamber outlet pointing vertically downwards. This is advantageous because the liquids are moved by gravity.

In another embodiment, the chamber outlet is connected to an angled outlet line. This can advantageously extend the range of application. It can be particularly advantageous if the outlet line can be rotated around an axis of the chamber outlet.

A still further embodiment provides that the chamber outlet is connected to a valve unit which comprises at least one valve. This enables an advantageous controlled discharge of the beverage.

In a further embodiment, the valve unit may comprise at least two valves, of which at least one valve is a cleaning valve, the drain of which is directed into a used water drainage/discharge system, and of which at least one valve is a beverage valve, the drain of which discharges a beverage prepared in the mixing chamber. In this way, it is advantageously possible for a user to never receive a poorly mixed beverage or clear water in their beverage vessel. Similarly, the mixing chamber can be rinsed directly after a product draw for light cleaning purposes. This rinse is then also fed directly through the open first valve into the drain. If the mixing chamber is cleaned with a cleaning agent, this can also be fed directly into the drain via the open first valve and does not have to be discharged through the beverage outlet or the second valve.

The valve unit can be designed as a 3/2-way valve, for example. Such a valve is available on the market at low cost and in high quality.

In another embodiment, the mixing chamber can be inserted into the beverage preparation device and removed from the beverage preparation device again, whereby a correct seating of the mixing chamber in a holder is detected by a limit switch or/and reed contact. Several advantages are achieved here. The assembly/disassembly is thereby simple, as a simple plugging of the mixing chamber onto a holder is possible. If the mixing chamber comprises a handle, it is advantageously easy to handle the mixing chamber.

In one embodiment, at least one flow guide element is arranged in the mixing chamber in the interior of the chamber. This makes it advantageously easy to influence the flow direction of the injected medium and the vortex. Such a flow guiding element can be an edge, wall or the like.

A still further embodiment provides that the mixing chamber comprises at least one attached deflection wall in the interior of the chamber, which is arranged in a path of a transport flow of the jet of the injected/flushed-in medium. In this way, the transport flow can be advantageously directed into a specific target area, which is the target area for filled-in instant powder, and thus improved mixing and dissolution can be enabled.

In a further embodiment, which is not part of the invention, at least one impeller device is arranged in the mixing chamber, which is driven by a flow. In this way, mixing and dissolving of instant powder in the flushed-in medium can be intensified. Another advantage is that no additional drives are required for the impeller device.

It is also advantageous if the at least one impeller device comprises at least one impeller which is mounted in a rotary bearing and comprises projections which are formed as teeth, edges, vanes or/and blades/scoops, since in this way it can easily be made possible for the projections formed as teeth, edges, vanes or/and blades/scoops to break up the filled in instant powder IP which is located in the vortex and which does not dissolve completely, so that this does dissolve completely.

In one embodiment of the method, the first and/or second medium can be delivered from at least one source by means of a pump and warmed, heated or cooled by a heat exchanger. Advantageously, many different instant beverages can be prepared in this way.

A further embodiment of the method provides that in the second chamber section a flow velocity of the first medium with the instant powder premixed therein is increased by conical design of the second chamber section, and that in the fourth chamber section a flow velocity of the instant beverage flowing through is increased by conical design of the fourth chamber section. These are simple measures, but they are advantageous for the flow behaviour of the media and the instant powder dissolved therein.

A still further advantageous embodiment of the method is created in that the mixing chamber is cleaned daily with a cleaning tablet and that the mixing chamber is removed from the beverage preparation device after a fixable operating time and cleaned in a dishwasher. In this way, cleaning is considerably simplified compared to the state of the art. Cleaning can be carried out extremely easily by means of the cleaning tablet. Thus, a so-called Clean-In-Place (CIP) function can be realised. Because of the geometry of the mixing chamber, daily cleaning can be carried out in this way. In a certain period of time, e.g. 7 days, the mixing chamber is simply pulled out of its holder and can be cleaned, e.g. in a dishwasher.

In a still further embodiment of the method, it is provided that a valve unit connected to a chamber outlet with at least one valve is controlled in such a way that, during a cleaning process, a cleaning liquid accumulates and acts up to an upper edge of the mixing chamber when the valve is closed, and runs out after acting by opening the valve. This enables simple and effective cleaning.

A still further embodiment provides that a valve unit connected to a chamber outlet with at least two valves is controlled in such a way that the first volumes in ml of a prepared instant beverage are first led directly into the outlet through the opened first valve as a cleaning valve, whereupon the first valve is closed and the second valve for the beverage is opened. This can advantageously enable a user not to receive an incorrect or poorly prepared beverage.

For a further advantageous quality of a prepared beverage, the second valve can be closed again shortly before the end of the dispensing of the beverage and the first valve can then be opened to direct the last volumes in ml of the beverage into the drain.

In a further embodiment of the method, which, however, is not part of the invention, it is provided that at least one impeller device arranged in the mixing chamber, which is driven by a flow, with an impeller which comprises projections which are designed as teeth, edges, blades or/and scoops, intensifies a mixing of instant powder and flushed-in medium. In this way, possible lumps of the instant powder can be broken up and dissolved. Furthermore, water can be additionally conveyed out of the chamber.

The beverage preparation device of the method may be the beverage preparation device described above.

The invention also offers other advantages.
No mixer or blender motor required.
Mixing and dissolution takes place only with two jets of liquid medium
The chamber sections have decreasing inner diameters in the course from the chamber inlet to the chamber outlet.
The main mixing of instant powder and medium as well as the dissolution of the instant powder in the medium takes place in a lower chamber section in a vortex.
An injection of the media is not completely tangential to the respective inner wall of the associated chamber sections.
No cover walls are required.
No air nozzles are necessary in the media supply lines.

In the following, the invention is described in more detail by means of embodiment examples with reference to the drawings. It is shown in:

FIG. 1: a schematic view of a prior art beverage preparation device;

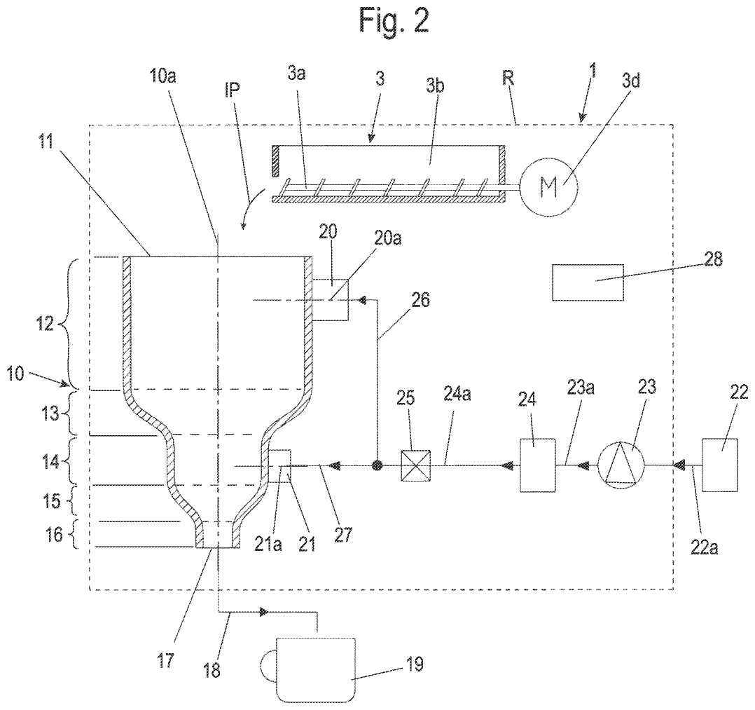

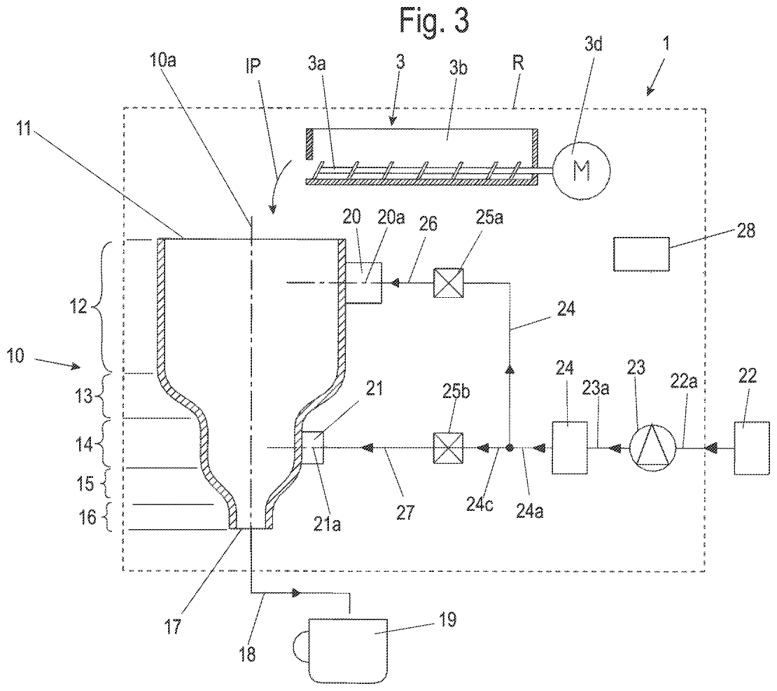

FIG. 2-3: schematic views of an embodiment of a beverage preparation device according to the invention;

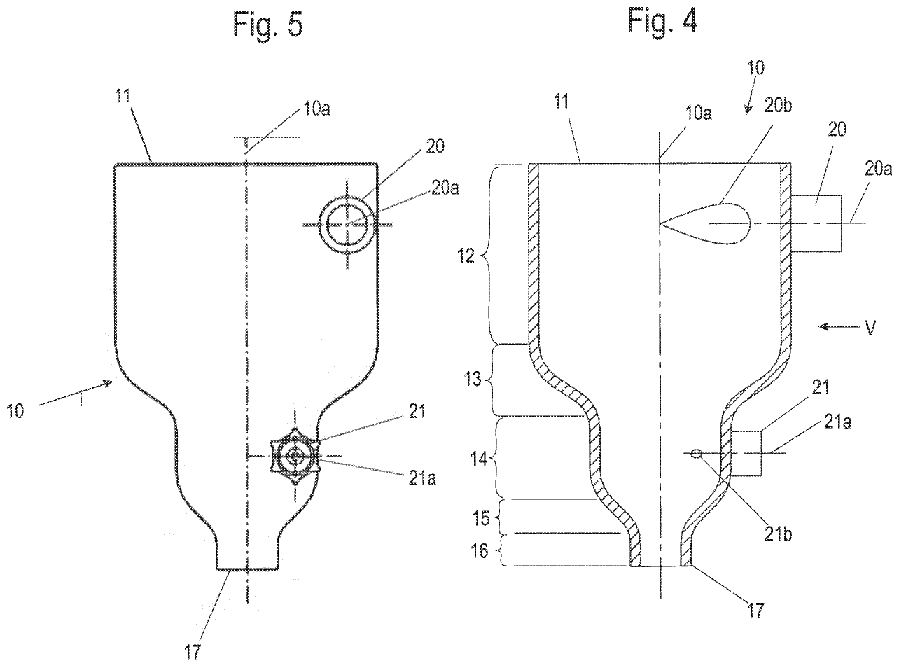

FIG. 4-5: Schematic representations of a mixing chamber;

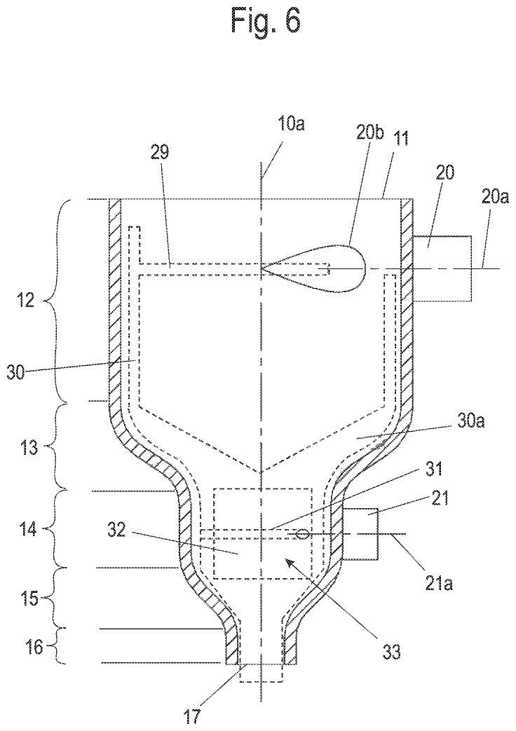

FIG. 6: a schematic sectional view of the mixing chamber according to FIGS. 4-5;

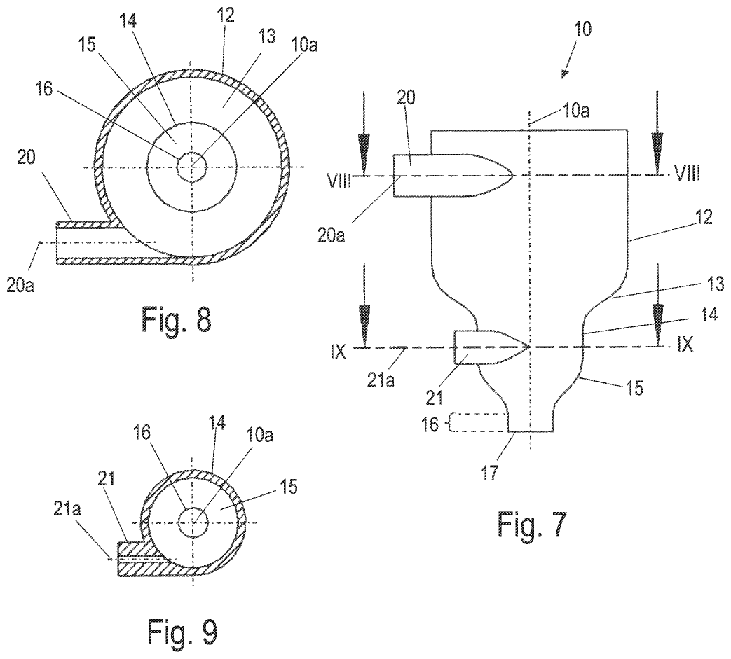

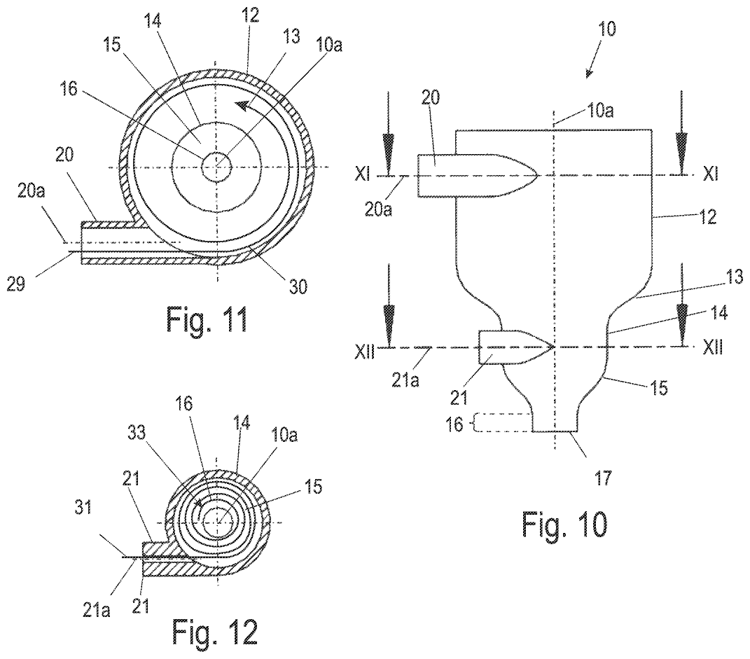

FIGS. 7, 10: schematic side views of the mixing chamber according to FIGS. 4-6;

FIGS. 8-9, 10-12: schematic sectional views along lines VIII-VIII and IX-IX of the mixing chamber in FIG. 7 and along lines IX-IX and X-X of the mixing chamber in FIG. 8;

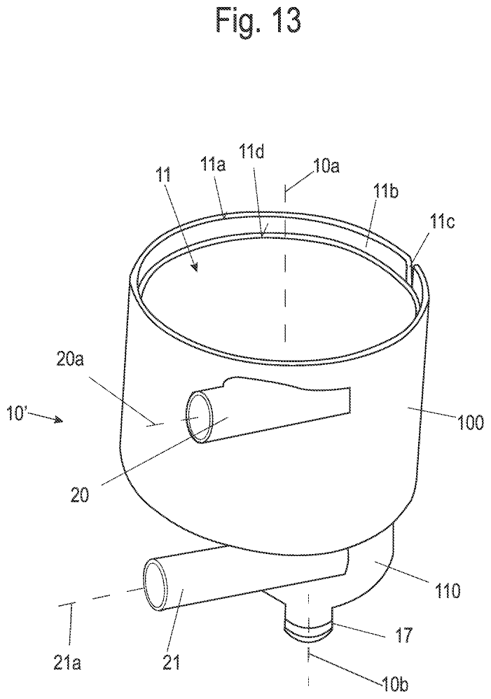

FIG. 13-17a: schematic illustrations of a further mixing chamber;

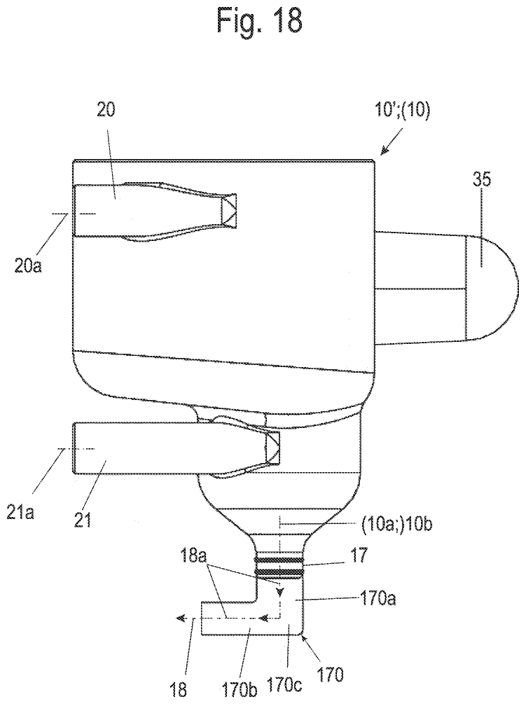

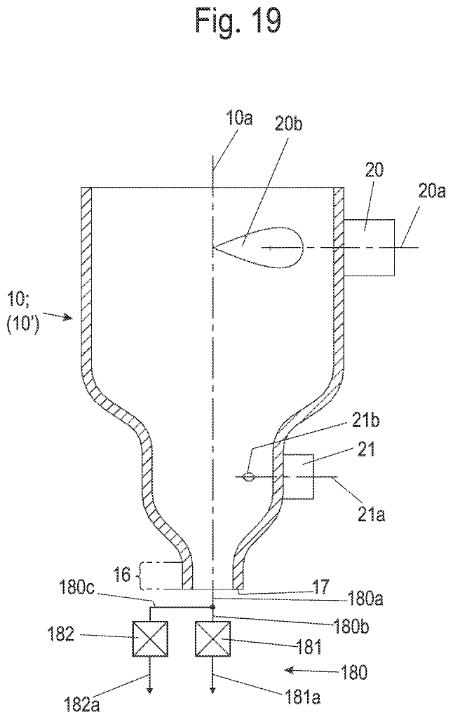

FIG. 18-19: schematic representations of variations of a chamber outlet;

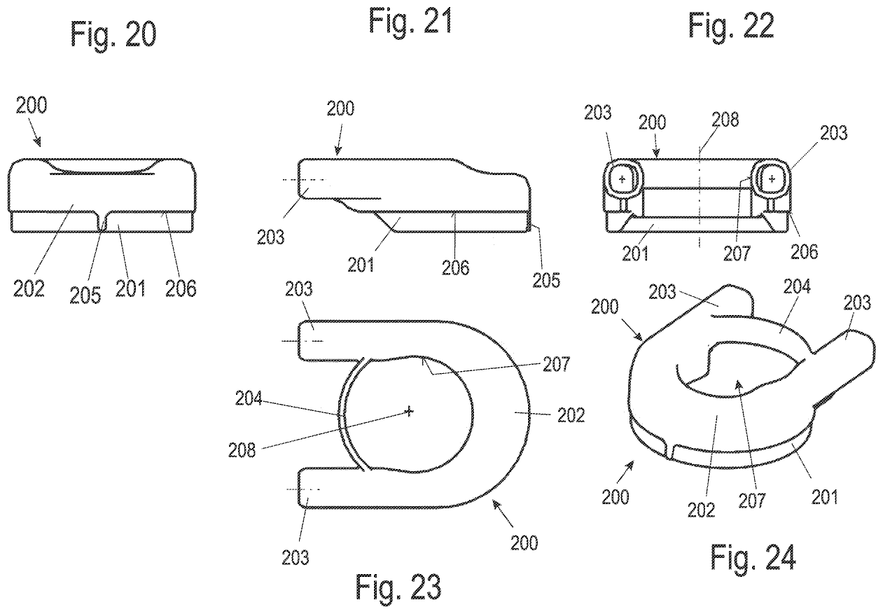

FIG. 20-24: schematic views of an extraction bonnet;

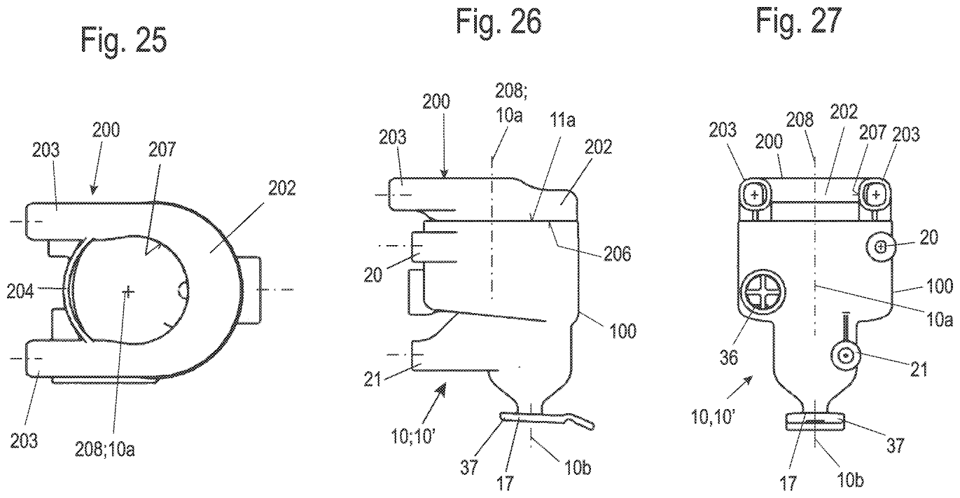

FIGS. 25-27: schematic views of the suction bonnet according to FIGS. 20-24 on the mixing chamber;

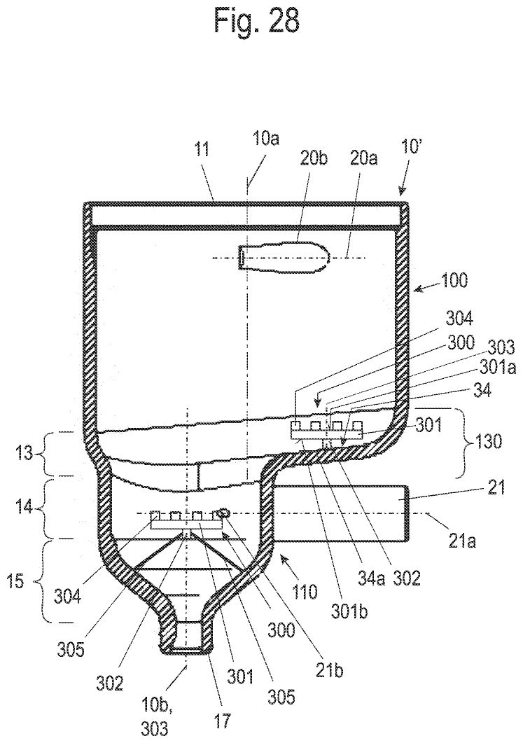

FIG. 28-30: schematic views of mixing chambers with impeller devices;

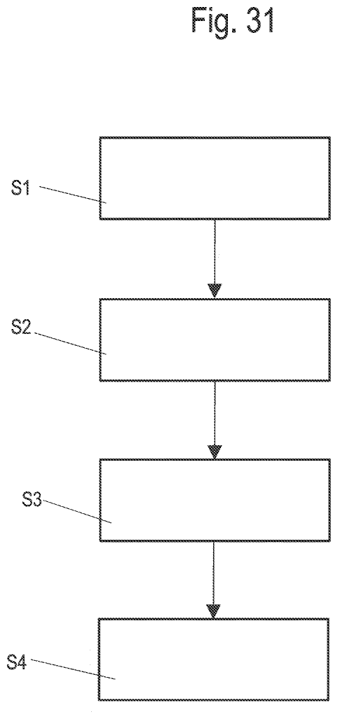

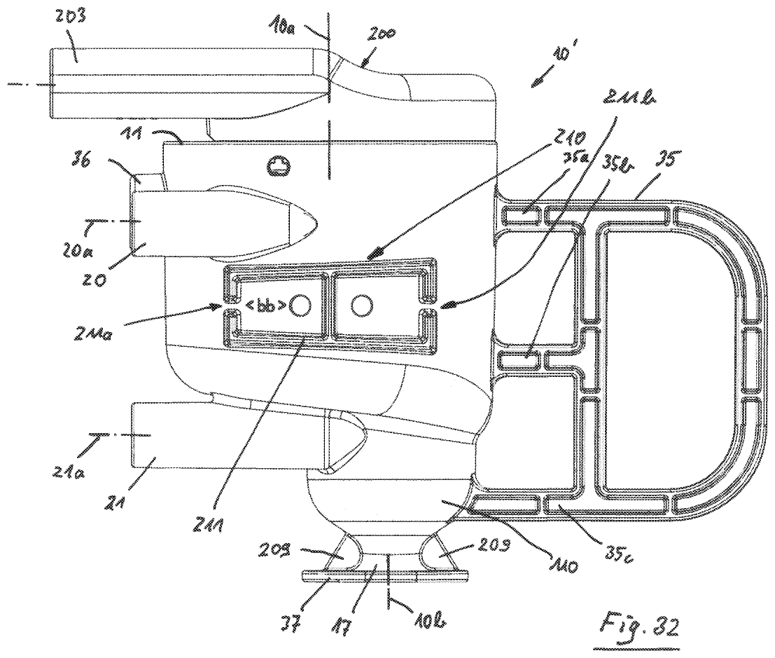

FIG. 31: a schematic flow diagram of a method according to the invention; and

FIGS. 32-34: schematic views of a variant of the beverage preparation device according to the invention.

FIG. 1 is already described above.

FIG. 2 shows a schematic view of an embodiment of a beverage preparation device 1 according to the invention. FIG. 3 shows a variant of the embodiment according to FIG. 2.

The dashed box symbolises a frame R of a housing of a beverage machine/beverage vending machine that comprises the beverage preparation device 1. The frame R can also be the housing of a so-called stand-alone beverage machine.

The beverage preparation device 1 comprises a conveyor system 3, a mixing chamber 10, a pump 23, a heat exchanger 24, a valve 25 and a control device 28.

The conveyor system 3 has already been described in connection with FIG. 1. In the version shown here, the conveyor element 3a is arranged horizontally and is rotatably driven by a drive 3d, e.g. an electric motor.

The mixing chamber 10 is formed as a one-piece hollow body rotationally symmetrical about a chamber axis 10a and is made, for example, from a plastic as an injection moulded part. The mixing chamber 10 is arranged vertically here. It comprises two flush-in connections 20, 21, which are arranged at a distance from each other in the direction of the chamber axis 10a.

The mixing chamber 10 comprises, in the direction of the chamber axis 10a, starting from an upper end of the mixing chamber 10 with a chamber inlet 11 to a lower end with a chamber outlet 17, five chamber sections 12 to 16 arranged one behind the other. In this arrangement, the inner diameters (clear diameters) of these chamber sections 12 to 16 decrease. These five chamber sections 12 to 16 are arranged alternately with cylindrical and conical inner surfaces one behind the other. In other words, hollow cylinders and hollow truncated cones alternate.

In a variant of the mixing chamber 10 not shown but easily imaginable, all chamber sections 12 to 16 are formed conically.

There is no dead space within the mixing chamber 12.

The first chamber section 12 is here a hollow cylinder with a circular cross-section. Approximately in its upper first third starting from the chamber inlet 11, a first flush-in connection 20 with a connection axis 20a is fitted in this example, the through opening of which opens into the first chamber section 12. This is described in more detail below. Here the connection axis 20a runs at right angles to the chamber axis 10a.

The first chamber section 12 is followed by the second chamber section 13 with a conical shape that tapers downwards and then merges into the third chamber section 14.

Like the first chamber section 12, the third chamber section 14 is designed as a hollow cylinder with a circular cross-section, whereby the diameter of the third chamber section 14 is smaller than that of the first chamber section 12. In a central region of the third chamber section 14, a second flush-in connection 21 is provided with a connection axis 21a extending here at right angles to the chamber axis 10a. This second flush-in connection 21 also comprises a through opening which opens into the third chamber section 14.

The lower end of the third chamber section 14 is connected to the fourth, conical chamber section 15, which tapers downwards and is connected to the fifth, hollow cylindrical chamber section 16 with a circular cross-section. A diameter of the fifth chamber section 16 is smaller than the diameter of the third chamber section 14 and also smaller than the diameter of the first chamber section 12.

The lower end of the fifth chamber section 16 forms the chamber outlet 17 with the smallest diameter of the mixing chamber 10. The chamber outlet 17 is here also concentric to the chamber axis 10a and is thus vertical like the fifth chamber section 16. A beverage 18 prepared in the mixing chamber 10 exits through this chamber outlet 17 as a finished product directly or, for example, via a further outlet as described further below, into a collecting container 19 provided for this purpose. The preparation of the beverage 18 is explained in more detail below.

The flush-in connections 20, 21 are used to flush in a medium, which in this example is water from a source 22. The source 22 can be, for example, the domestic water network, a domestic water supply, a tank or the like. The source 22 is connected to a pump 23 of the beverage preparation device 1 via a feed line 22a. A shut-off device that is not shown can be inserted in this feed line 22a, e.g. a manually and/or electromagnetically adjustable valve.

The pump 23 is connected to a heat exchanger 24 via a pump line 23a. The heat exchanger 24 comprises heating or/and cooling. The heat exchanger 24 is connected to a valve 25 via a line 24a. The valve 25 is here a solenoid valve. In the embodiment example according to FIG. 2, its outlet branches into a first supply line 26 to the first flush-in connection 20 and into a second supply line 27 to the second flush-in connection 21.

In the variant according to FIG. 3, each flush-in connection 20, 21 is assigned its own valve 25a, 25b. The line 24a coming from the heat exchanger 24 branches into a first line 24b and a second line 24c. The first line 24b is connected to a first valve 25a. A second valve 25b is connected to the second line 24c. The first valve 25a is connected to the first flush-in connection 20 via the first supply line 26, the second valve 25b being connected to the second flush-in connection 21 via the second supply line 27.

In a variant not shown but easily imaginable, the flush-in connections 20, 21 are supplied with different media. For example, the first flush-in connection 20 can be supplied with water as already shown in FIG. 3. The second flush-in connection 21 can be connected separately to a second installation (source 22, pump 23, heat exchanger 24, pipes) and be supplied with a different medium, e.g. juice, flavouring. In this way it is possible to mix three different media (instant powder IP, water and e.g. milk) in the mixing chamber 10.

The control device 28 is used to control the electrical components, namely drive 3d of the conveyor system 3, pump 23, heat exchanger 24, valves 25, 25a, 25b and possibly shut-off valve and others, which will be described below. A control device with operating elements and signalling elements or display is not shown, but is easily imaginable.

When the beverage preparation device 1 is in operation, the medium, for example water, flows from the source 22 under pressure from the pump 23 into the heat exchanger 24, which heats or cools the medium depending on the type of beverage, and from there either via the one valve 25 (FIG. 2) into both flush-in connections 20 and 21 or via the first valve 25a into the first flush-in connection 20 and via the second valve 25b into the second flush-in connection 21 (FIG. 3).

It is possible in the case of two valves 25a, 25b that only one of the flush-in connections 20, 21 is used, the other remaining unused by not opening or switching on its associated valve 25a, 25b.

The medium is then flushed into the first chamber section 12 of the mixing chamber 10 through the first flush-in connection 20. The second flush-in connection 21 flushes further medium, in this case also water, into the third chamber section 14. The drive 3d of the conveyor system 3 rotates the conveyor element 3a, which conveys the instant powder IP from the storage container through the chamber inlet 11 into the first chamber section 12 of the mixing chamber 10. In the first chamber section 12, a premixing of instant powder IP with the water introduced from the first flush-in connection 20 takes place. This is described in more detail below.

The thus pre-mixed instant powder IP then flows with the injected water from the first chamber section 12 through the narrowing second chamber section 13, increasing a flow velocity, into the third chamber section 14.

In the third chamber section 14, the premix of instant powder IP and water is intensively mixed to completion by flushing in further water through the second flushing-in port 21, whereby the instant powder IP dissolves completely in the medium. This is described in more detail below.

Finally, this finished mixture, i.e. the finished product, continues to flow by gravity downwards through the tapering fourth chamber section 15, further increasing a flow rate of the product, into the fifth chamber section 16. From the chamber outlet 17, the mixed finished beverage 18 then continues to flow, driven by gravity, into the collection container 19.

FIG. 4 shows a longitudinal section of the mixing chamber 10. FIG. 5 shows a side view V of the mixing chamber 10 from FIG. 4.

In the first chamber section 12 of the mixing chamber 10, an flush-in opening 20b of the first flush-in connection 20 is shown. The flush-in opening 20b extends through the wall of the first chamber section 12 here at right angles to the chamber axis 10a. However, it is also possible that the connection axis 20a of the flush-in connection 20 and thus of the flush-in opening 20b lies at an angle to the chamber axis 10a that is greater than or less than 90°. In other words, the water introduced through the first flush-in connection 20 could then be inducted with a slight upward inclination towards the chamber inlet 11 or also with a slight or greater downward inclination towards the second chamber section 13. This can also be realised, for example, by means of an adjustable flush-in opening 20b or/and with adjustable deflection walls.

A flush-in opening 21b of the second flush-in connection 21 extends through the wall of the third chamber section 14 and comprises a smaller width than the flush-in opening 21a of the first flush-in connection 20. This flush-in opening 21b is also arranged with the connection axis 21a here at right angles to the chamber axis 10a. It is also possible here that the connection axis 21a of the flush-in connection 21 and thus of the flush-in opening 21b lies at an angle to the chamber axis 10a which is greater or smaller than 90°.

In the example shown, a respective induction flow or induction jet of the flush-in connections 20, 21 is aligned in such a way that it hits the associated inner wall of the respective chamber section 12, 14 laterally in each case.

The flush-in opening 20b of the first flush-in connection 20 and/or the flush-in opening 21b of the second flush-in connection 21 may also be arranged such that the induction jet is directed towards the opposite inner wall of the respective chamber section 12, 14.

FIG. 6 shows a schematic sectional view of the mixing chamber 10 according to FIG. 4-5 with a schematic representation of induction areas and flow distributions inside the mixing chamber 10.

A first jet 29 from the flush-in opening 20b of the first flush-in connection 20 initially extends in the direction of a plane of the port axis 20a of the first flush-in connection 20 perpendicular to the chamber axis 10a, flows around the inner wall of the first chamber section 12 and distributes in rotation about the chamber axis 10a on the inner wall of the first chamber section 12.

Premixing of the injected instant powder IP in the first chamber section 12 depends on the filling position and type of filling of the instant powder IP. If the filling position is aligned with the chamber axis 10a, only a small amount of premixing takes place in the first chamber section 12, as the injected medium with its transport flow 30 initially remains in the wall area of the first chamber section 12. Only in the second, conical chamber section 13 does mixing begin in the transport flow 30a.

If, in this filling position, the filling method is such that the instant powder IP is filled over a large area, pre-mixing takes place earlier, i.e. in a central area of the first chamber section 12.

Pre-mixing can also be intensified if the filling position of the instant powder IP is arranged in an edge area or directly above the jet 29.

It is possible that the filling position and/or the filling method can be adjustable, either manually and/or electrically.

In the process, the instant powder IP introduced through the chamber inlet 11 (see FIGS. 2, 3) is premixed with the flushed-in water. A transport flow 30, 30a is formed, which rotates around the chamber axis 10a and flows downwards through the second, conical chamber section 13 into the third chamber section 14, increasing its flow velocity.

In the fourth chamber section 15, a second jet 31 is injected from the flush-in opening 21b (see FIG. 4) of the second flush-in connection 21, which extends in the direction of a plane of the port axis 21a of the second flush-in connection 21 perpendicular to the chamber axis 10a. As a result, a main area with a vortex area 33 is formed in a mixing area 32.

FIGS. 7 and 10 each show a schematic side view of the mixing chamber 10 according to FIGS. 4 to 6.

FIG. 8 shows a schematic sectional view along line VIII-VIII according to FIG. 7 in a sectional plane of the connection axis 20a of the first flush-in connection 20 at right angles to the chamber axis 10a as seen from above into the mixing chamber 10. The connection axis 20a runs through the through opening of the first flush-in connection 20 as the secant of an imaginary circle of the inner wall of the first chamber section 12 in projection in the drawing plane of FIG. 8. In FIG. 8, the conical second chamber section 13, the wall of the third chamber section 14, the conical fourth chamber section 15 and the wall of the fifth chamber section 16 arranged concentrically to the chamber axis 10a can also be clearly seen.

A section along line IX-IX according to FIG. 7 in a sectional plane of the connection axis 21a of the second flush-in connection 21 at right angles to the chamber axis 10a as seen from above into the mixing chamber 10 is shown in FIG. 9. The through-opening of the second flush-in connection 21 is here formed with a considerably smaller inner diameter than that of the through-opening of the first flush-in connection 20. FIG. 9 shows the third chamber section 14, the fourth conical chamber section 15 and the fifth chamber section 16.

FIGS. 10, 11 and 12 correspond to FIGS. 7, 8 and 9 respectively, where a flushing behaviour is shown in FIGS. 11 and 12.

FIG. 11 shows a section along line XI-XI according to FIG. 10 through the first chamber section 12. The jet 29 is schematically indicated as a current thread and initially runs parallel to the connection axis 20a of the first flush-in connection 20. Then the jet 29 meets the inner wall of the first chamber section 12, flows around it rotating about the chamber axis 10a as transport currents 30 and 30a (see FIG. 6).

In the sectional view along line XII-XII according to FIG. 10, FIG. 12 shows the rinsing behaviour in the third chamber section 14. The inner diameter of the third chamber section 14 is considerably reduced compared to the chamber sections 13 and 12 above it. The jet 31 hits the inner wall of the third chamber section 14 with a correspondingly high flow velocity from the small through opening of the second flush-in connection 21 and is set into rapid rotation around the chamber axis 10a. This forms the strong vortex in the vortex area 33 (see FIG. 6).

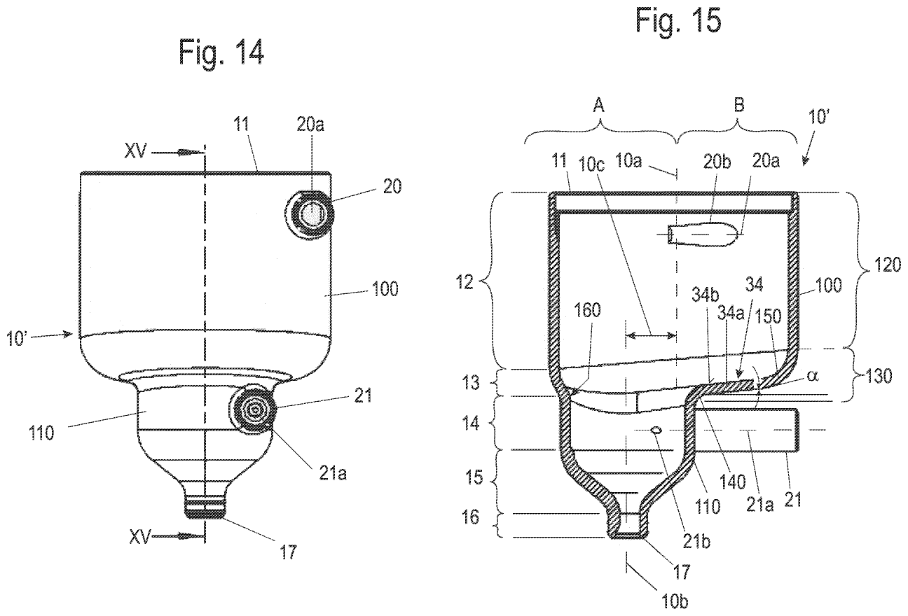

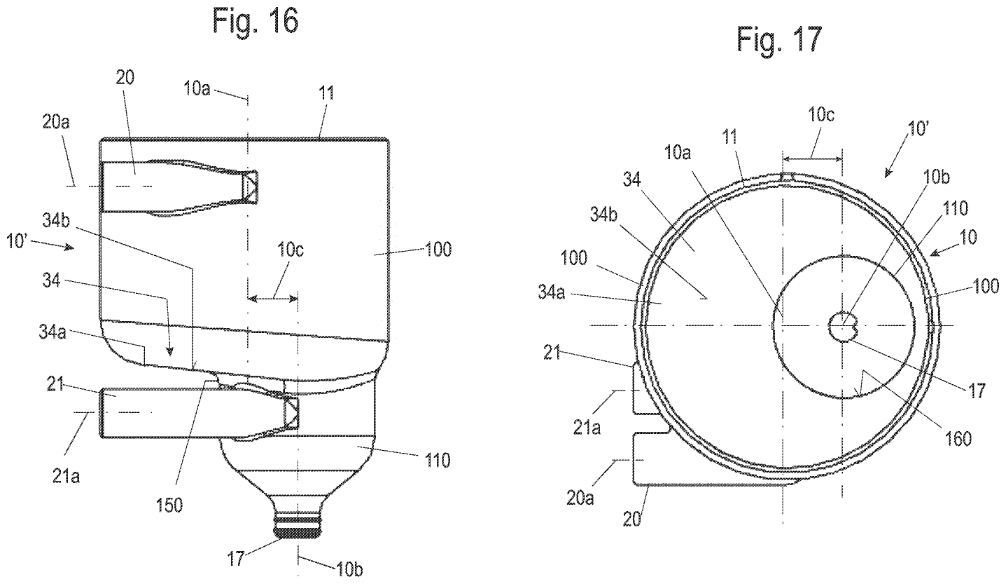

FIGS. 13 to 17a show schematic representations of a further mixing chamber 10′, which is shown in a schematic perspective view in FIG. 13. FIG. 14 shows a view of the further mixing chamber 10′ on connection openings of the flush-in connections 20, 21. FIG. 15 shows a sectional view of the further mixing chamber 10′ along line XV-XV according to FIG. 14. In FIG. 16 the further mixing chamber 10′ is shown in a further side view, in which the flush-in connections 20, 21 are seen from the side.

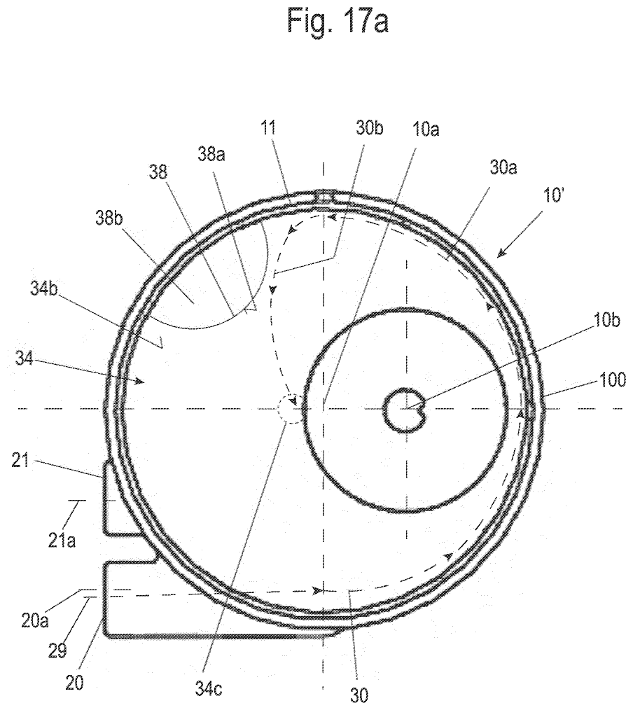

FIG. 17 shows a top view of the further mixing chamber 10′ looking into the further mixing chamber 10′ through the chamber inlet 11. FIG. 17a shows a variant of the further mixing chamber 10′.

The functional principle of the further mixing chamber 10′ corresponds to the above-described functional principle of the mixing chamber 10 according to FIGS. 2 to 12. There is only a small difference with regard to the instant powder IP during filling.

In contrast to the mixing chamber 10 according to FIGS. 2 to 12, the further mixing chamber 10′ comprises an asymmetrical structure.

The asymmetrical structure consists of a first or upper chamber 100 that is arranged with the chamber axis 10a asymmetrical to and connected to a second, respectively lower chamber 110. The lower chamber 110 comprises a chamber axis 10b which, however, does not extend in the chamber axis 10a of the upper chamber 100. The upper chamber 100 and the lower chamber 110 are therefore not arranged concentrically as in the mixing chamber 10 according to FIGS. 2 to 12.

Furthermore, FIG. 13 shows a design of the chamber inlet 11 of the mixing chamber 10′. The chamber inlet 11 of the mixing chamber 10 described above can also be designed in this way.

In the upper region of the chamber inlet 11, the circumferential wall of the chamber 100 is reduced in its radial thickness by approximately half, starting from a front side 11a downwards into the chamber 100, so that a kind of circumferential web is formed as an edge 11b with a front side 11a and a step 11d. In this way, an inner diameter of the edge 11b is larger than an inner diameter of the chamber 100. A recess 11c is formed in the edge 11b extending parallel to the chamber axis 10a. The recess 11c extends in the edge 11b from the front side 11a thereof to the step 11d and serves as a centring for a suction bonnet 200, which will be described in more detail below.

FIG. 15 shows the further mixing chamber 10′ in its construction with chamber sections, whereby FIG. 14 defines the sectional view according to FIG. 15 in a vertical plane of the chamber axis 10a along line XV-XV.

The chamber axis 10a of the upper chamber 100 and the chamber axis 10b of the lower chamber 110 are offset from each other by an offset 10c. The chambers 100 and 110 are thus arranged eccentrically to each other.

The upper chamber 100 comprises a larger inner diameter and a larger outer diameter than the lower chamber 110. In the sectional view according to FIG. 15, the further mixing chamber 10′ can be seen divided into an area A lying here to the left of the chamber axis 10b of the lower chamber 110 and an area B lying to the right of the chamber axis 10b of the lower chamber 110.

In the left-hand area A, the division of the chamber sections 12 to 16 is the same as in the mixing chamber 10 according to FIGS. 2 to 12.

In the right-hand area B, the lower chamber 110 comprises the same chamber sections 14 to 16 as in the mixing chamber 10 according to FIGS. 2 to 12. As with the mixing chamber 10 according to FIGS. 2 to 12, the upper chamber 100 also comprises two chamber sections 120 and 130 which are arranged one behind the other in the direction from above, i.e. viewed from the chamber inlet 11.

However, the upper chamber section 120 of the upper chamber 100 in region B is shorter in the direction of the chamber axis 10a than the chamber section 12 in region A. The upper chamber section 130 of the upper chamber 100 in region B is longer in the direction of the chamber axis 10a than the chamber section 13 in region A.

The chamber section 130 is formed with a plane section 34 comprising a floor 34a with an inner surface 34b. The floor 34a connects an outwardly convex curved circumferential wall portion 140 of the chamber section 130 to an outwardly concave wall portion 150 of the chamber section 130.

The base 34a is provided with an opening 160, here circular, which forms the inlet to the lower chamber 110 and is located in the chamber sections 13, 130.

The floor 34a is arranged with a circumferential angle α to a horizontal slightly inclined inwards, i.e. to the chamber axis 10b of the lower chamber. The angle α has a value that lies in a range of 5° to 10°, preferably 7° to 8°. This is illustrated in FIG. 16 in a side view and in FIG. 17 with a top view of this floor 34a with its inner surface 34b pointing upwards. The floor 34a is arranged in a kind of crescent around the opening 160 of the lower chamber 110, as can be seen in FIG. 17. The crescent-shaped base 34 is inclined circumferentially towards the chamber axis 10b of the lower chamber 110.

It is also possible for the plane section 34 to be formed with the base 34a as an insert part.

The difference in filling the instant powder IP is explained below.

In the further mixing chamber 10′, the instant powder IP is fed into the upper chamber 100 through the chamber inlet 11 in such a way that it falls into a target area 34c on the inner surface 34b of the floor 34a of the plane section 34. This target area is offset a small distance from the chamber axis 10a towards the side of the flush-in connections 20, 21. This is illustrated in FIG. 17a.

This has the advantage that the chamber 100 does not become clogged so quickly if the instant powder IP ever enters the chamber 100 when no flushing is active. This can happen when the storage container 3b is filled with instant powder IP. In such a case, the instant powder IP in the mixing chamber 10 according to FIGS. 2 to 12 would fall through to the chamber outlet 17 and stick there. Such sticking can lead to blockages, whereby it can happen that the mixing chamber 10 would overflow.

In the variant of the further mixing chamber 10′, a deflection wall 38 is formed in the interior of the chamber 100 at its inner geometry, which is located here on the side of the flush-in connections 20, 21, whereby it is opposite these. The deflection wall 38 is arc-shaped, comprises an outer surface 38a and extends from the floor surface 34b to the chamber inlet 11. There is a tight connection of the deflection wall 38 with the floor surface 34b and the inner wall of the chamber 100. In this way, the deflection wall 38 defines an inner space 38b together with the floor surface 34b and the inner wall of the chamber 100. This inner space 38b can also be closed from above with a ceiling wall that is not shown.

As already shown in FIG. 11, the jet 29 of the injected medium passes through the first injection port 20 into the chamber 100 and becomes the transport flow 30 and 30a. The transport flow 30a then flows against the outer surface 38b of the deflection wall 38. In this way, the resulting vortex is somewhat broken. The transport flow is thus deflected towards the centre of the chamber 100 in the direction of the chamber axis 10a as transport flow 30b into the target area 34c of the incident instant powder IP. This has the advantage that the transport flow 30b is directed as a vortex precisely to the point in the target area 34c where the instant powder IP falls into the chamber 100.

The positioning of the deflection wall 38 may also be variable. For example, depending on how the instant powder IP falls into the chamber 100, the deflector wall 38 can be arranged in such a way that the transport flow 30b is directed precisely into the target area 34c of the incident instant powder IP. This is the case, for example, with a machine variant with two storage containers for instant powder IP for two different types of instant powder IP. Here, two chutes may be provided for the instant powder IP, with a different destination area 34c being formed.

The deflector wall 38 can also be formed as a simple edge. It is also possible that the deflector wall 38 is an insert part.

The deflection wall 38 forms a so-called flow guide element. Further flow guide elements can be provided in the mixing chamber 10, 10′ at different locations in order to guide flows and/or vortices in their direction in a targeted manner.

FIGS. 18 and 19 show schematic representations of variations of a chamber outlet 17 of the mixing chambers 10 and 10′.

In FIG. 18, instead of a chamber outlet 17 leading vertically straight downwards, an angled outlet line 170 is provided. The outlet line 170 comprises a first, straight vertical line section 170a and a second, horizontal line section 170b. The first line section 170a connects the outlet line 170 to the chamber outlet 17 and is connected to the second line section 170b via an angle section 170c. In this example, the angle section 170c is a 90° angular bend.

In this way, the outflow of the beverage 18 no longer takes place vertically downwards, but in an angled flow path 18a via the curved line section 170 below the last reduction of the diameter of the mixing chamber 10, 10′, to the rear or to a certain side. Such an outlet line 170 is possible both for the mixing chamber 10 according to FIGS. 2 to 12 and for the further, asymmetrical mixing chamber 10′. The outlet line 170 can of course also have other deflection angles than 90°. It is also conceivable that the outlet line 170 is arranged rotatably around the chamber axis 10a or 10b so that it can be rotated to any side.

In addition, FIG. 18 shows a handle 35 attached to one side of the mixing chamber 10, 10′. In this example, the handle 35 is attached to the side facing away from the connections of the flush-in connections 20, 21. This makes it easier to handle the mixing chamber 10, 10′ when removing and inserting it.

FIG. 19 shows a sectional view of the mixing chamber 10 with a valve unit 180. Of course, this can also be the other mixing chamber 10′.

The valve unit 180 is connected to the chamber outlet 17 via an inlet 180a.

The valve unit 180 comprises a first valve 181 and a second valve 182. Both valves 181, 182 are each connected to the inlet 180a via an inlet 180b, 180c. Each valve 181, 182 also comprises its own outlet 181a, 182a.

Here, for example, the first valve 181 is provided as a cleaning valve, the outlet 181a of which is led directly into a used water drainage system. The second valve 182 is used as a beverage valve, the outlet 182a of which leads into a beverage vessel.

With the valve unit 180, it is possible to achieve better rinsing operations and/or cleaning of the mixing chamber 10, 10′ or beverage preparation device 1. Thus, the first volumes in ml of a prepared instant beverage can first be fed directly into the drain through the opened first valve 181. Then the first valve 181 is closed and the second valve 182 for the beverage 18 is opened. The second valve 182 is then closed again shortly before the end of the delivery of the beverage 18, at which point the first valve 181 is opened to allow the final volumes in ml of beverage 18 to be delivered to the drain.

In this way, it is possible that a user will never get a poorly mixed beverage or clear water in their beverage vessel. Similarly, the mixing chamber 10, 10′ can be rinsed directly after a product draw for light cleaning purposes. This rinse is then also fed directly through the open first valve 181 into the drain. If the mixing chamber 10, 10′ is cleaned with a cleaning agent, this can also be fed directly through the opened first valve 181 into the drain and does not have to be discharged through the beverage outlet or the second valve 182. Further process advantages are conceivable.

In a simplified embodiment, the valve unit 180 can also have only one valve 181. In this case, the cleaning liquid can then accumulate and act up to the upper edge of the mixing chamber 10, 10′ with valve 181 closed. Afterwards, however, the cleaning liquid is discharged to the front through the normal outlet. This is not shown, but is easily imaginable.

The valve unit 180 can, for example, be designed as a 3/2-way valve or with a similar structure. The valve unit 180 can be controlled by the control device. The valve control can be triggered automatically or/and manually. It is also conceivable that the valve unit 180 can be equipped with manually operable additional valves that can also be used in the event of a power failure.

FIGS. 20-24 show schematic views of an extraction bonnet 200. A front view is shown in FIG. 20. FIG. 21 shows a side view and FIG. 22 a connection side of the extraction bonnet 200. FIG. 23 shows a top view. FIG. 24 shows a perspective view.

The extraction bonnet 200 comprises a downwardly projecting wall 201, a connection section 202 mounted thereon and comprising two connections 203, and a stiffening section 204. The stiffening section 204 may be optional.

The connection section 202 is semi-circular arc-shaped. The connections 203 are tangentially attached to the ends of the connection section 202 parallel to each other. Interiors of the connections 203 are connected to an interior of the connection section 202, which in turn is open downward. The connection section 202 and the connections 203 form the shape of a U, with the two connections 203 being connected to the arcuate stiffening section 204 at their opposite sides. The arc-shaped stiffening section 204 and the arc-shaped connection section 202 both have the same outer diameter.

An outer diameter of the wall 201 is smaller than an outer diameter of the arcuate connection section 202, thereby forming a projection 206 between the wall 201 and the connection section 202.

The connection section 202, transition regions between the connections 203 and the connection section 202, and the arcuate stiffening portion 204 define a substantially circular through opening 207 comprising a centre 208.

A lug 205 extending downwardly from the projection 206 of the connection section 202 on the outside of the wall 201 is formed opposite the opening of the U-shape and projects radially outwardly from the wall 201.

FIG. 25-27 show schematic views of the suction bonnet 200 according to FIG. 20-24 inserted into the mixing chamber 10, 10′. FIG. 25 shows a top view, FIG. 26 a side view and FIG. 27 a rear view.

The suction bonnet 200 is mounted or inserted on the chamber 100 in such a way that the wall 201 is received inside the chamber inlet 11 in the recess 11c of the edge 11b. The projection 206 of the suction bonnet 200 rests on the front side 11a of the mixing chamber 10, 10′.

The nose 205 forms a centring of the suction bonnet 200 with the recess 11c of the edge 11b of the chamber inlet 11 of the chamber 100 of the mixing chamber 10, 10′, whereby the nose 205 is positively received in the recess 11c of the edge 11b. The suction bonnet 200 is positioned in relation to the mixing chamber 10, 10′ in such a way that the connections 203 point to the side of the mixing chamber 10, 10′ on which the flush-in connections 20, 21 are arranged.

The through opening 207 of the suction bonnet 200 is arranged above the chamber inlet 11, whereby the chamber axis 10a here passes through the centre point 208 of the through-opening 207. It is also possible that the chamber axis 10a and the centre 208 are not superimposed, but are displaced.

A holder 36 is arranged on the side of the connections 20, 21, 203 as exemplarily shown in FIG. 27. This holder 36 is circular with a cross stiffener and is used to hold a magnet. This magnet can be screwed, glued or clamped to the holder 36. The task of such a magnet is to trigger a magnet-sensitive switching element, e.g. a reed switch, when the mixing chamber 10, 10′ is inserted in the associated machine.

Furthermore, the underside of the chamber outlet 17 in this example is provided with a sealing section 37. When the mixing chamber 10, 10′ is installed, it is pushed into the associated machine. In the process, the sealing section 37 is pushed over a silicone part arranged in the machine, which is not shown here, resulting in a sealing surface. On the one hand, this sealing surface prevents the leakage of instant beverage at this point, and on the other hand, it prevents the chamber outlet 17 from drawing air. Such an air draft would worsen the discharge behaviour of the instant beverage.

For a safe insertion of the mixing chamber 10, 10′ into the machine, a guide device is installed in the machine, which cooperates with a guide unit 210 (see FIGS. 32 and 34). The guide device serves to ensure that the mixing chamber 10, 10′ with its guide unit 210 can only be inserted into the machine in one position. During the further insertion process, the mixing chamber 10, 10′ is automatically centred and is arranged in the correct end position when the insertion process is completed. This is advantageous as it enables safe handling of the mixing chamber 10, 10′ and error-free installation.

FIGS. 28-30 show schematic views of mixing chambers 10, 10′ with impeller devices 300, which, however, are not part of the invention.

FIG. 28 shows a first embodiment of an impeller device 300 in two different positions.

The impeller device 300 comprises an impeller 301 with a bearing 302 and a shaft 303 as well as projections 304. The impeller 301 is mounted rotatably about the shaft 303 by means of the bearing 302. The projections 304 are formed as teeth and/or edges, here arranged on a plate surface 301a of the impeller 301 and project axially from the plate surface 301a. The projections 304 can also be arranged on both plate surfaces 301a, 301b or/and radially circumferentially on the impeller 301.

The plate surfaces 301a, 301b may also have moulded grooves with corresponding edges.

The upper disc surface 301a here points upwards to the chamber inlet 11, the lower disc surface 301b points to the chamber outlet 17.

In a first position, the impeller 301 is located in the chamber section 130 of the upper chamber 100 and is mounted with the bearing 302 on the plane section 34 of the floor 34a of the mixing chamber 10′ onto which the instant powder IP to be filled falls. The shaft 303 is substantially parallel to the chamber axis 10a, 10b, with the disc surfaces 301a, 301b being perpendicular to the chamber axis 10a, 10b.

The rotatable impeller 301 is driven by the vortex in the mixing chamber 10′. The vortex is generated as described above by the jet of medium flushed in through the first flush-in connection 20. The impeller 301 is thus not driven by the direct jet, but is rotated by means of the flow of the vortex acting on the projections 304.

The projections 304, which are formed as teeth and edges, break up the filled instant powder IP, which has not yet completely dissolved in the whirlpool, when it clumps.

In a second position, the impeller 301 is located in the chamber section 14/15 of the lower chamber 110 in the discharge area before the chamber outlet 17.

Here, the jet from the flush-in opening 21b of the second flush-in connection 21 is directed in a tangential direction towards the projections 304 of the impeller 301 and directly drives the impeller 301. It is also possible that the vortex rotates the impeller 301.

Here, the bearing 302 is attached to the wall of the lower chamber 110 by means of holders 305, for example in the form of support rods.

In the example shown, the axis 303 is parallel to the chamber axis 10b, with the disc surfaces 301a, 301b being perpendicular to the chamber axis 10b.

In a variant not shown, the shaft 303 of the impeller 301 in the chamber section 14/15 is arranged at right angles to the chamber axis 10b. The jet from the flush-in opening 21b of the second flush-in connection 21 is also directed in a tangential direction towards the projections 304 of the impeller 301. The disc surfaces 301a, 301b lie here in planes parallel to a plane in which the chamber axis 10b lies. Of course, the impeller 301 can also be arranged in an inclined position, in which the planes of the disc surfaces 301a, 301b are inclined to the plane with the chamber axis 10b.

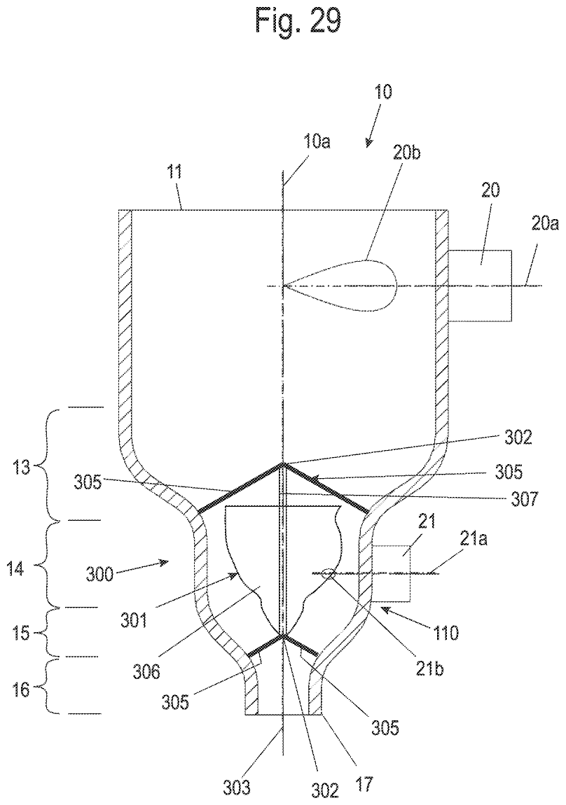

A second embodiment of the impeller device 300, which is not part of the invention, is shown in FIG. 29.

This impeller 301 is a type of turbine arranged directly in the outlet area (chamber sections 13, 14, 15). The impeller 301 comprises blades 306 as projections 304 (see FIG. 28), which are arranged and shaped to form turbine blades.

In the example shown, the axis 303 of the impeller 301 is parallel or aligned with the chamber axis 10a.

The impeller 301 is attached to a shaft 307, for example, which is rotatably mounted in bearings 302 at its ends. The impeller 301 is thus rotatable around the axis 303 or chamber axis 10a.

The bearings 302 are here attached to the wall of the lower chamber 110 by holders 305, for example in a linkage of support rods.

The blades 306 forming the turbine scoops are directly impinged upon by the jet from the flush-in opening 21b of the second flush-in connection 21, causing the impeller 301 to rotate about the axis 303. The turbine scoops are geometrically designed in such a way that they convey in the direction of the chamber outlet 17. Thus, water is additionally conveyed out of the chamber.

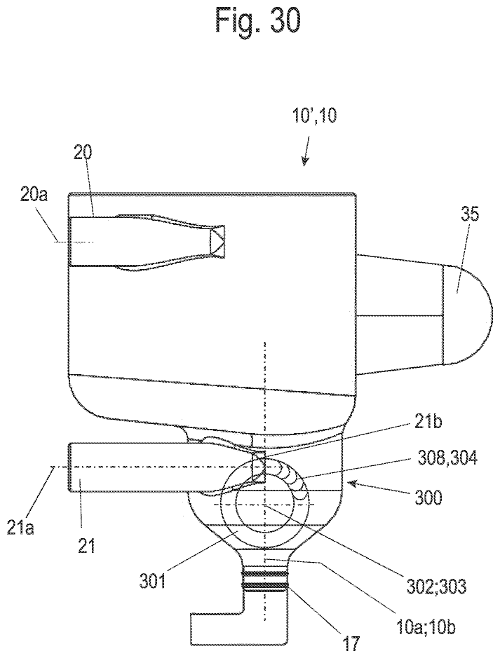

FIG. 30 shows a third embodiment of the impeller device 300, which is not part of the invention.

Here, the impeller 301 is designed like an overshot water mill impeller with scoops 308 as projections 304 and is laterally rotatably mounted in a bearing 302 in the lower constriction above the chamber outlet 17. The impeller shaft 303 is perpendicular to the chamber axis 10a, 10b.

The jet from the flush-in opening 21b of the second flush-in connection 21 is also directed in a tangential direction towards the scoops 308 of the impeller 301, rotating the impeller 301. This is to break up the instant powder IP somewhat and mix it better.

FIG. 31 shows a schematic flow chart of a method according to the invention for preparing a beverage with the beverage preparation device 1 according to the invention.

In a first method step S1, a beverage preparation device 1 comprising a one-piece mixing chamber 10, 10′ with two flush-in connections 20, 21 is provided.

In a second process step S2, the first flush-in port 20 is supplied with a first medium and flushes this in a first jet 29 into a first chamber section 12 of the mixing chamber 10, 10′. The first medium is delivered from a source 22 by means of a pump 23 and warmed, heated or cooled by a heat exchanger 24.

In a third process step S3, instant powder IP is introduced into the first chamber section 12 of the mixing chamber 10, 10′ and is premixed with the first medium flushed in through the first flush-in connection 20 and is transported by the first medium further down the mixing chamber 10, 10′ through a second chamber section 13 into a third chamber section 14. In the second chamber section 13, a flow velocity of the first medium with the instant powder IP premixed therein is increased by conical design of the second chamber section 13.

In a fourth process step S4, a second medium is injected in a second jet 31 through the second flush-in connection 21 into a third chamber section 14 of the mixing chamber 10, 10′ creating a vortex. As a result, the instant powder IP is completely mixed with the medium and mixed in the medium to form a beverage, which is then dispensed through a vertically positioned fifth chamber section 16. Dispensing occurs after the beverage thus prepared has flowed through a fourth chamber section 15, its flow velocity having been increased by the conical design of the fourth chamber section 15.

It is very easy to assemble the mixing chamber 10, 10′ with the beverage preparation device 1 in a beverage machine, a stand-alone version, a coffee machine and the like. The mixing chamber 10, 10′ comprises no seals between the chamber sections 12 to 16 and 120 to 130 as wearing parts. It is therefore a seal-free system.

Cleaning is possible in a simple way with a cleaning tablet, with which a so-called Clean-In-Place (CIP) function can be realised. Due to the geometry of the mixing chamber 10, 10′, daily cleaning can be carried out using a tablet. In a certain period of time, e.g. 7 days, the mixing chamber 10, 10′ is simply pulled out of its holder (not shown here) and can be cleaned, e.g. in a dishwasher. This is made much easier by the handle 35 (see FIG. 18).

For example, a limit switch, reed contact or the like can be used to monitor whether the mixing chamber 10, 10′ is correctly seated in its holder. This means that the beverage preparation device 1 can only be put back into operation when the mixing chamber 10, 10′ is correctly inserted again.

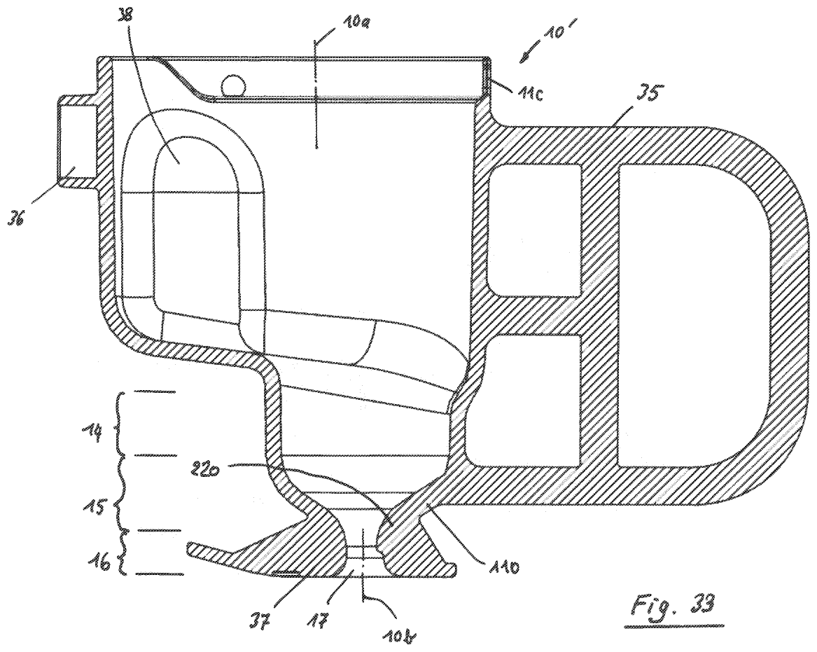

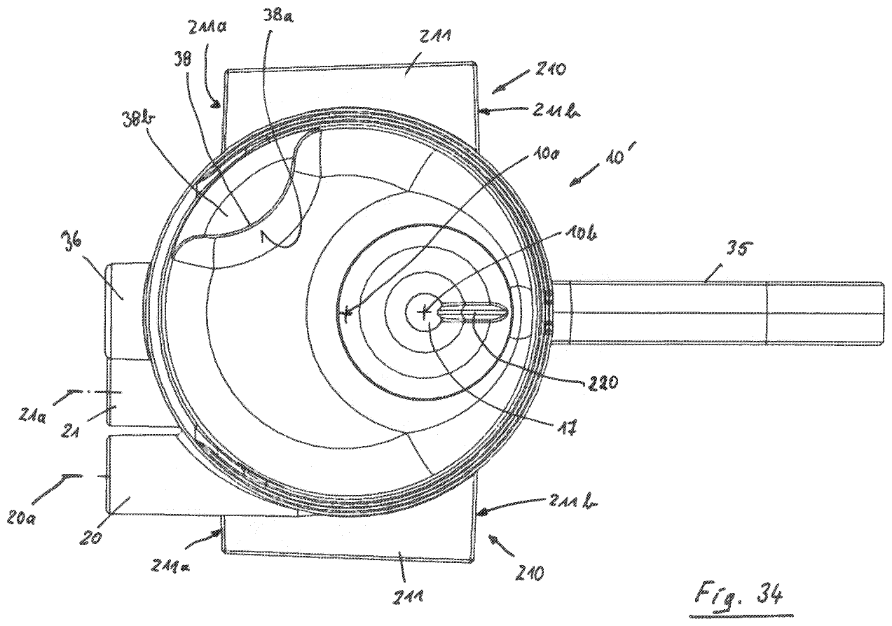

FIGS. 32-34 are schematic views of a variant of the beverage preparation device 1 according to the invention, with FIG. 32 showing a side view. FIG. 33 shows a sectional view. FIG. 34 shows a top view looking into the mixing chamber 10′ through the chamber inlet 11.

The variant of the beverage preparation device 1 shown in FIGS. 32-34 differs from the illustration in FIGS. 15/26-27 in the following respects.

The handle 35 comprises almost the same length of the mixing chamber 10′ in the direction of the chamber axis 10a. The handle 35 is attached to the mixing chamber 10′ with three handles 35a-c, the lowest handle 35c being attached to the wall of the lower chamber 110. In the example shown, the handle 35 with its handles 35a-c is integrally formed with the mixing chamber 10′.

The holder 36 for receiving a magnet is arranged centrally on the mixing chamber 10′ in an upper area below the chamber inlet 11.

The sealing section 37 at the chamber outlet 17 is stiffened to the outer wall of the lower chamber 110 by two ribs 209.

The guide unit 210 comprises a guide projection 211 on each side of the mixing chamber 10′. Each guide projection 211 protrudes from the wall of the mixing chamber 10′ and corresponds to the not shown but easily imaginable guide device in the associated machine. Each guide projection 211 comprises a front end 211a facing the flush-in connections 20, 21 and a rear end 211b facing the handle 35. The front end 211a is tapered relative to the rear end 211b both in the direction of the chamber axis 10a and in the direction of the connection axes 20a, 21a. Furthermore, the front end 211a protrudes from the mixing chamber 10′ by a shorter length with respect to the rear end 211b. In this way, insertion of the beverage preparation device 1 into the guide device is facilitated.

In the lower chamber 110, a web 220 is arranged on the inner wall 1 facing the handle 35. The web 220 protrudes from the inner wall and runs in the chamber sections 15 and 16 of the lower chamber 110, starting in the chamber section 15 and ending in the chamber outlet 17.

For example, the bar 220 comprises a width of approximately 2 mm and a thickness of 0.6 mm. The thickness of 0.6 mm protrudes into the outlet. The width 2 mm may be in a range of 1.5 to 2.5 mm. The thickness of 0.6 mm may be more in the range of 0.4 to 1 mm.

The web 220 is used to influence the outlet flow in the lower chamber 110 for further mixing.

The structure of the mixing chamber 10′ of the beverage preparation device 1 according to the invention is free of mixer/mixing wheels. A drive device, e.g. electric motor, for such mixer/mixing wheels (impeller units) are not required.

The invention is not limited by the embodiments given above, but can be modified within the scope of the claims.

For example, it is conceivable that the method of filling the instant powder IP into the mixing chamber 10, 10′ can be by means of (variable) vibration of a chute, or by vibration of the conveyor system 3.

### REFERENCE SIGNS

1, 1′ Beverage preparation device
2 Mixing chamber
2a Chamber section
2b Suction bonnet
2c Tube section
2d Inlet
3 Conveyor system
3a Conveyor element
3b Storage container
3c Chute
3d Drive
4 Mixing chamber
5 Mixer wheel
6 Mixer drive
7 Holder
8 Bearing seal
8a Housing seal
9 Drain
10, 10′ Mixing chamber
10a, 10b Chamber axis
10c Offset
11 Chamber inlet
11a Front side
11b Edge
11c Recess
11d Step
12-16 Chamber section
17 Chamber outlet
18 Beverage
18a Flow path
19 Collection container
20, 21 Flush-in connection
20a, 21a Connection axis
20b, 21b Flush-in opening
22 Source
22a Feed line
23 Pump
23a Pump line
24 Heat exchanger
24a, 24b, 24c Line
25, 25a, 25b Valve
26, 27 Supply line
28 Control device
29, 31 Jet
30, 30a, 30b Transport flow
32 Mixing area
33 Vortex area
34 Plane section
34a Floor
34b Inner surface
34c Target area
35 Handle
36 Holder
37 Sealing section
38 Deflection wall
38a Exterior surface
38b Interior
100, 110 Chamber
120, 130 Chamber section
140, 150 Wall section
160 Opening
170 Outlet line
170a, 170b Line section
170c Angle section
180 Valve unit
180a, 180b, 180c Inlet
181, 182 Valve
181a, 182a Outlet
200 Suction bonnet
201 Wall
202 Connection section
203 Connection
204 Stiffening section
205 Nose
206 Projection
207 Through opening
208 Centre
209 Rib
210 Guide unit
211 Guide projection
211a, 211b End
220 Web
300 Impeller device
301 Impeller
302 Bearing
303 Shaft
304 Projection
305 Holder
306 Blade
307 Shaft
308 Scoop
A, B Range
IP Instant Powder
R Frame
S1-S4 Method step
α Angle

1. A beverage preparation device (1) for preparing instant beverages, comprising: a conveyor system (3), a mixing chamber (10′), at least one pump (23), at least one heat exchanger (24), at least one valve (25) and a control device (28),
wherein the mixing chamber (10′) comprises at least two flush-in connections (20, 21) configured for respectively injecting a jet (29, 31) of a liquid medium into the mixing chamber (10′), wherein the at least two flush-in connections (20, 21) are arranged at a distance from each other in a direction of a chamber axis (10a) of the mixing chamber (10′),
wherein the mixing chamber (10′) comprises chamber sections (12, 13, 14, 15, 16, 120, 130) arranged one behind the other, wherein inner diameters of said chamber sections (12, 13, 14, 15, 16, 120, 130) decrease starting from a chamber inlet (11) of the mixing chamber (10′) to a chamber outlet (17) of the mixing chamber (10′),
wherein
the chamber sections (12, 13, 14, 15, 16, 120, 130) arranged one behind the other are all formed with conical inner surfaces, and wherein
the mixing chamber (10′) comprises an asymmetrical structure, which is free of mixer/mixing wheels, with a first chamber (100) and a second chamber (110) which are arranged one behind the other, a chamber axis (10a) of the first chamber (100) and a chamber axis (10b) of the second chamber (110) being displaced with an offset (10c) with respect to one another and thus being arranged eccentrically with respect to one another.

2. The beverage preparation device (1) according to claim 1, wherein the first chamber (100) of the mixing chamber (10′) is formed with a plane section (34) that comprises a floor (34a) with an inner surface (34b), said floor (34a) being arranged with a circumferential angle α to a horizontal slightly inclined inwardly towards the chamber axis (10b) of the second chamber (110), said angle α has a value in a range of 5° to 10°.

3. The beverage preparation device (1) according to claim 1, wherein the mixing chamber (10′) is made of a metal material, a plastic or a combination of metal material and plastic and is designed to be seal-free.

4. The beverage preparation device (1) according to claim 1, wherein a first flush-in connection (20) of the at least two flush-in connections (20, 21) comprises a through opening which opens into a first chamber section (12, 120) of the chamber sections of the mixing chamber (10′), and wherein a second flush-in connection (21) of the at least two flush-in connections (20, 21) comprises a through opening which opens into a third chamber section (14) of the chamber sections of the mixing chamber (10′).

5. The beverage preparation device (1) according to claim 4, wherein the through opening of the second flush-in connection (21) comprises a smaller internal diameter than that of the through opening of the first flush-in connection (20).

6. The beverage preparation device (1) according to claim 4, wherein the first flush-in connection (20) and the second flush-in connection (21) are configured to be preset or adjustably supplied with a medium or different media simultaneously or with a time delay via a common valve (25) or in each case via a separate valve (25a, 25b) independently of one another.

7. The beverage preparation device (1) according to claim 4, wherein the first flush-in connection (20) and the second flush-in connection (21) are configured to be preset or adjustably supplied with a medium or with different media simultaneously or with a time delay via a separate valve (25a, 25b) in each case.

8. The beverage preparation device (1) according to claim 1, wherein the mixing chamber (10′) is arranged vertically and comprises a chamber outlet (17) pointing vertically downwards.

9. The beverage preparation device (1) according to claim 8, wherein the chamber outlet (17) is connected to an angled outlet line (170).

10. The beverage preparation device (1) according to claim 8, wherein the chamber outlet (17) is connected to a valve unit (180) which comprises at least one valve (181).

11. The beverage preparation device (1) according to claim 8, wherein the valve unit (180) comprises at least two valves (181, 182) wherein at least one valve (181) of the at least two valves is a cleaning valve that has an outlet (181a) directed into a used water discharge system, and wherein at least one valve (182) of the at least two valves is a beverage valve that has an outlet (182a) that discharges a beverage (18) prepared in the mixing chamber (10′).

12. The beverage preparation device (1) according to claim 1, wherein the mixing chamber (10′) is configured to be inserted into the beverage preparation device (1) and removed again from the beverage preparation device (1), wherein a correct seating of the mixing chamber (10′) in a holder is detected by a limit switch or/and reed contact.

13. The beverage preparation device (1) according to claim 1, wherein at least one flow guiding element is arranged in the mixing chamber (10′) in an interior space of the chamber (100, 110).

14. The beverage preparation device (1) according to claim 13, wherein the mixing chamber (10, 10′) comprises, in the interior space of the chamber (100), at least one attached deflection wall (38) which is arranged in a path of a transport flow (30a, 30b, 30c) of the jet (29, 31) of the injected medium.

15. A beverage machine comprising at least one beverage preparation device (1) according to claim 1.
